(19) United States
(12) Patent Application Publication
(10) Pub. No.: US 2025/0365303 A1
(43) Pub. Date: Nov. 27, 2025

(54) SYSTEMS AND METHODS FOR DETECTING FRAUD THROUGH ARTIFICIAL INTELLIGENCE (AI) AGENT TESTING

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,096

(22) Filed: May 22, 2025

(30) Foreign Application Priority Data
May 22, 2024 (IN) 202311079237

(51) Int. Cl. H04L 9/40

(52) U.S. Cl. CPC H04L 63/1425; H04L 63/1483

(57) ABSTRACT

The present disclosure provides a system and method for detecting fraud through artificial intelligence (AI) agent testing by focusing on authorized inferential knowledge boundaries. The method includes receiving a plurality of data types including factual data and derived inferential knowledge associated with an inferential knowledge profile of the AI agent; executing tests such as clone detection (detecting imitation based on inference patterns) and validate user (aligning behavior with user profiles potentially including inferred characteristics). Crucially, the method involves retrieving factual data access permissions and explicitly defined inference permissions from a secure cloud-based enclave and comparing the AI agent's observed behavior and demonstrated inferences against these authorized inferential boundaries through a validation test. Fraud events are detected based on these comprehensive tests, enabling robust governance of AI agents, particularly in marketplace environments, by ensuring they operate within their legitimate knowledge and inference scope.

### CROSS REFERENCE TO RELATED APPLICATIONS

This patent application claims priority to Indian Patent Application No. IN 202311079237, filed May 22, 2024, entitled “SYSTEMS AND METHODS FOR DETECTING FRAUD THROUGH ARTIFICIAL INTELLIGENCE (AI) AGENT TESTING” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for detecting fraud through artificial intelligence (AI) agent testing.

### BACKGROUND

The development of robust fraud detection systems has become an essential component in various domains, including finance, e-commerce, and cybersecurity. Detecting fraud, whether it is perpetrated by internal or external actors, has grown increasingly critical to maintaining the integrity and security of systems and data. This need arises from the ever evolving and sophisticated techniques employed by fraudsters, necessitating advanced and adaptive methods to counter fraudulent activities.

In the realm of fraud detection, both individual users and central monitoring systems play pivotal roles. From an individual perspective, it is crucial to ascertain that one's actions are not misconstrued as fraudulent, ensuring that their identity and activities remain secure. Simultaneously, central systems are tasked with the formidable responsibility of tracking and preventing fraud within an entire system, safeguarding the interests of all users and stakeholders. Currently, there is an increase in the challenges posed by the rising sophistication of fraudsters, the diversity of data types, real-time detection requirements, user privacy concerns, large-scale data volumes, the issue of false positives, and the complexities of multi-stakeholder ecosystems in industries such as finance and e-commerce.

Existing AI agent validation and fraud detection systems are largely limited to checking explicit facts or enforcing basic rule-based logic. However, they fall short when dealing with AI agents that operate within allowed factual inputs but misuse inferred knowledge. These agents may make decisions based on unauthorized inferences-behaviors that are difficult to detect using traditional methods focused only on surface-level data compliance.

Furthermore, a major challenge lies in managing and protecting inferential knowledge, which can be highly sensitive and revealing. Existing platforms lack mechanisms to control how AI agents derive new insights from permitted data. There is no standard approach to test whether an AI agent is making inferences it is authorized to make, leading to unchecked reasoning paths and potential misuse. In AI agent marketplaces, this gap poses significant risks. Agents may overstep their boundaries-accessing data beyond their scope or making inferences that violate user consent or platform policies. Because these inferences are not easily auditable, it's difficult to prove when an agent has misbehaved or exceeded its authorized capabilities. This lack of verifiable evidence hinders accountability and allows misuse to go undetected, especially in complex or dynamic decision-making environments.

Consequently, there is a need for improved systems and methods for detecting fraud through artificial intelligence (AI) agent testing.

### OBJECTS OF THE INVENTION

Some of the objects of the present disclosure, which at least one embodiment herein satisfy, are listed herein below.

It is an object of the present subject matter to overcome the afore mentioned and other drawbacks existing in the prior art systems and methods.

It is a significant object of the present subject matter to design and develop a system and an associated method for detecting fraud in artificial intelligence (AI) agents by testing not only the agents' access to factual data but also their inferential knowledge and derived behavioral patterns.

It is another object of the present subject matter to design and develop the system such that the system facilitates the generation and validation of inferential knowledge profiles corresponding to AI agents, enabling detection of unauthorized inference-based behaviors.

It is another object of the present subject matter to design and develop the system such that the system integrates a secure cloud-based enclave for managing both factual and inferred knowledge while enforcing permissioned inferential boundaries for AI agents.

It is yet another object of the present subject matter to design and develop the system such that the system conducts multiple layers of AI agent testing including user validation, clone detection, and inference boundary validation to identify fraudulent activity.

It is even another object of the present subject matter to design and develop the system such that the system supports governance of AI agents in a digital marketplace, enabling trust score adjustments, agent de-listing, and audit-based accountability mechanisms.

It is another object of the present subject matter to design and develop the system such that the system dynamically adapts to user behavior and context, enabling real-time evolution of inferential knowledge profiles for accurate fraud detection.

It is another object of the present subject matter to design and develop the system such that the system leverages multi-modal data sources including voice tone, timing, behavior, and interaction patterns to strengthen inference modeling and testing.

It is yet another object of the present subject matter to design and develop the system such that the system ensures privacy-preserving inference validation using cryptographic protocols, including zero-knowledge proofs and differential privacy.

It is another object of the present subject matter to design and develop the system such that the system establishes tamper-proof audit logs of agent behavior, permissions, and inference testing results to support legal, ethical, and contractual enforcement.

It is even another object of the present subject matter to design and develop the system such that the system is compatible with AI agent marketplaces and governance ecosystems, thereby ensuring ease of integration and implementation.

These and other objects and advantages of the present subject matter, will be apparent to a person skilled in the art after consideration of the following detailed description, taken into consideration with accompanied drawings in which preferred embodiments of the present subject matter are illustrated.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter. A core aspect of the present subject matter lies in its capability to not only not only to manage factual data, but also to actively track, model, and test against the derived inferential knowledge associated with AI agents. This functionality is particularly significant in the governance of AI agents, such as those operating within a marketplace, by ensuring that each agent operates strictly within its authorized inferential boundaries, as managed and verified through a secure cloud-based enclave.

In an embodiment, the present invention discloses a method for detecting fraud through artificial intelligence (AI) agent testing. The method includes receiving, by a fraud detection module, a plurality of data types including factual data and derived inferential knowledge associated with an inferential knowledge profile of the AI agent; executing, by the AI agent test module, at least one of a clone detection test or a validate user test, wherein the clone detection test configured to detect whether the AI agent is imitating another agent or identity based on inference patterns or response characteristics; and the validate user test configured to verify whether the AI agent behavior aligns with a known user identity or profile; retrieving, from a secure could-based enclave, the factual data access permissions and explicitly defined inference permissions associated with the AI agent; comparing, by a validation test, the AI agent's observed data access permission and inference permissions with the factual data access permissions and explicitly defined inference permissions to detect unauthorized or excessive inferential behavior; and detecting, by the fraud detection module, a fraud event based on outputs from at least one of the clone detection test, validate user test or validation test.

In an aspect, the method includes initiating at least one remedial action upon detection of the fraud event.

In an aspect, the remedial action includes but not limited to AI agent suspension, trust score reduction, user notification, or logging the fraud event in an immutable audit log.

In an aspect, the secure cloud-based enclave stores the inferential knowledge profile comprising authorized inference types, reference behavior models, and context-sensitive access conditions for each AI agent.

In an aspect, the secure cloud-based enclave maintains immutable audit logs detailing the data access, inferential permissions granted, and the inferences actually made by the AI agent.

In an aspect, the method includes tracking and enforcing permission to infer within the secure cloud-based enclave as an auditable right.

In another aspect, the secure cloud-based enclave is configured to apply differential privacy techniques before releasing aggregated inferential knowledge data of each AI agent for external analysis to prevent reverse engineering of individual profiles.

In another embodiment, the present invention discloses a system for detecting fraud through artificial intelligence (AI) agent testing. The system includes one or more processors; and a memory storing programmed instructions executable by the one or more processors. The one or more processors execute the programmed instructions to: receive, by a fraud detection module, a plurality of data types including factual data and inferred data with an inferential knowledge profile of the AI agent; execute, by an AI agent test module, at least one of a clone detection test or a validate user test, wherein: the clone detection test is configured to detect whether the AI agent is imitating another agent or identity based on inference patterns or response characteristics; and the validate user test is configured to verify whether the AI agent behavior aligns with a known user identity or behavior profile; retrieve, from a secure cloud-based enclave, factual data access permissions and explicitly defined inference permissions associated with the AI agent; compare, by a validation test module, the AI agent's observed data access and inference permissions with the retrieved permissions to detect unauthorized or excessive inferential behavior; and detect, by the fraud detection module, a fraud event based on outputs from at least one of the clone detection test, validate user test or validation test.

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

It is to be noted, however, that the appended drawings illustrate only typical embodiments of the present subject matter and are therefore not to be considered for limiting its scope, for the invention may admit to other equally effective embodiments. A detailed description is given with reference to the accompanying figures. In the figures, a reference number identifies the figure in which the reference number first appears. The same numbers are used throughout the figures to refer like features and components. Some embodiments of system or methods or structure in accordance with embodiments of the present subject matter are now described, by way of example, and with reference to the accompanying figures, in which

FIG. 1 illustrates an exemplary block diagram representation of a network architecture implementing a system for detecting fraud through artificial intelligence (AI) agent testing, in accordance with an embodiment of the present disclosure;

FIG. 2 illustrates an exemplary block diagram representation of a computer implemented system, such as those shown in FIG. 1, capable of detecting fraud through artificial intelligence (AI) agent testing, in accordance with an embodiment of the present disclosure;

FIG. 3 illustrates an exemplary flow diagram representation of fraud detection through artificial intelligence (AI) agent testing, in accordance with an embodiment of the present disclosure. and

FIG. 4 illustrates a flow chart of a method for detecting fraud through artificial intelligence (AI) agent testing, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is therefore intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. The appearance of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for detecting fraud through artificial intelligence (AI) agent testing.

An Artificial Intelligence (AI) agent, as referred to in the present disclosure, is a specialized intelligent component capable of perceiving its environment, processing data, and performing tasks autonomously or semi-autonomously to achieve specific goals. AI agents may include system AI agents, support AI agents, and local AI agents, each specializing in different functions such as decision-making, data extraction, or privacy preservation. These agents may communicate with each other and external systems using defined protocols and interfaces, such as APIs, to collaboratively manage tasks in shared environments.

These AI agents operate in synergy to manage complex shared applications, such as those used in smart homes or smart city environments. By leveraging techniques such as contextual enrichment, neural network-based user modeling, and throttling mechanisms, the agents enhance personalization, ensure efficient resource use, and safeguard system integrity. This collaborative framework allows the system to adapt dynamically to user behavior, maintain operational continuity, and provide enriched, secure outputs while preserving user privacy and system reliability.

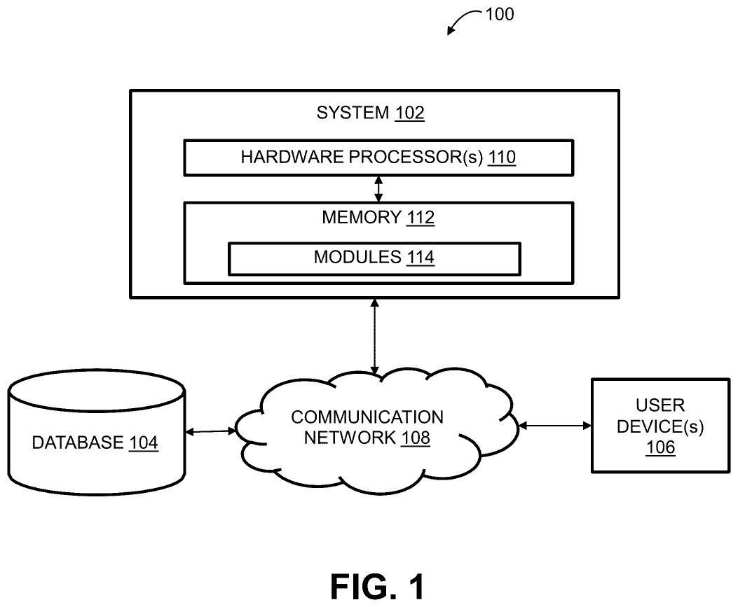

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system 102 for detecting fraud through artificial intelligence (AI) agent testing, in accordance with an embodiment of the present disclosure. According to FIG. 1, the network architecture 100 includes a system 102, a database 104, and one or more user devices 106. The one or more user devices 106 may be associated with one or more users and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for detecting fraud through artificial intelligence (AI) agent testing. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented with hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for detecting fraud through artificial intelligence (AI) agent testing. Execution of the machine-readable program instructions by the hardware processor 110 may enable the proposed system 102 to detect fraud through artificial intelligence (AI) agent testing. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may conduct a plurality of tests of artificial intelligence (AI) agent, each encompassing a comprehensive range of data types stored in the data repository, spanning from factual, immutable data to inferred data types.

In an exemplary embodiment, the system 102 may consider a categorization process as it progresses through the funnel, accounting for variations and changes.

In an exemplary embodiment, the system 102 may conduct tests on data that has been pre-approved through an agreed-upon registration process, representing fixed items that the central server is authorized to access and assess. In cases where another system is queried, and it provides a response closely resembling the authorized data, suspicions of duplication may be raised. If a sufficient number of such similarities are identified, it would trigger the identification and flagging of a potential duplicate agent.

In an exemplary embodiment, the system 102 may conduct validation tests to ascertain the user's identity and compare it with that of the AI Agent (not shown). These tests may involve data collected directly from the user during key interaction points or at the time of registration.

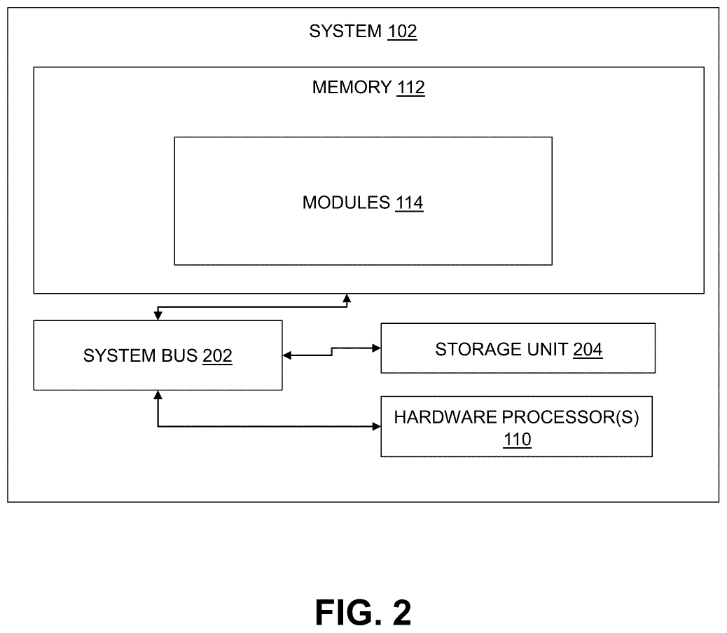

FIG. 2 illustrates an exemplary block diagram representation of a computer implemented system 102, such as those shown in FIG. 1, capable of detecting fraud through artificial intelligence (AI) agent testing, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to test, data types, profiles any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may conduct a plurality of tests of artificial intelligence (AI) agent, each encompassing a comprehensive range of data types stored in the data repository, spanning from factual, immutable data to inferred data types.

In an exemplary embodiment, the plurality of modules 114 may consider a categorization process as it progresses through the funnel, accounting for variations and changes.

In an exemplary embodiment, the plurality of modules 114 may conduct tests on data that has been pre-approved through an agreed-upon registration process, representing fixed items that the central server is authorized to access and assess. In cases where another system is queried, and it provides a response closely resembling the authorized data, suspicions of duplication may be raised. If a sufficient number of such similarities are identified, it would trigger the identification and flagging of a potential duplicate agent.

In an exemplary embodiment, the plurality of modules 114 may conduct validation tests to ascertain the user's identity and compare it with that of the AI Agent (not shown). These tests may involve data collected directly from the user during key interaction points or at the time of registration.

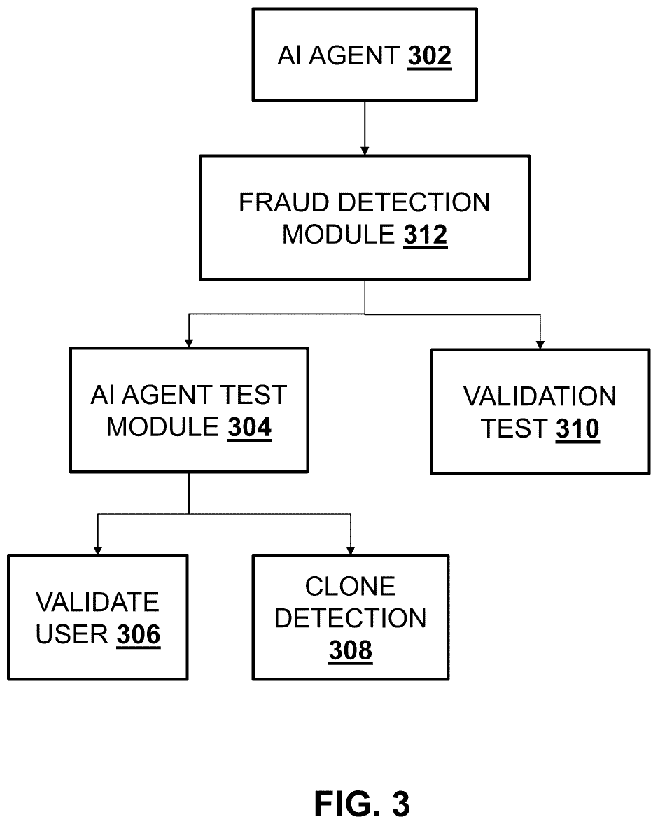

FIG. 3 illustrates an exemplary flow diagram representation of fraud detecting through artificial intelligence (AI) agent testing, in accordance with an embodiment of the present disclosure. For instance, within this framework, a multitude of tests involving artificial intelligence (AI) agent 302 are conducted for fraud detection 312, all with the aim of identifying instances of fraud. Typically, the activities, identity, and knowledge claims (both factual and inferred) of the AI agent 302 is under scrutiny to identify fraud, which may explicitly includes misuse or misrepresentation of inferential knowledge. The tests within this framework are notably comprehensive, spanning a wide spectrum of data types meticulously stored within the system's extensive data repository. This spectrum ranges from factual, immutable data, which includes elements like user profiles and transaction records, to more nuanced inferred data types, encompassing user behavior patterns, interaction histories, and various other data attributes. The tests may be utilized to evaluate the AI agent 303. These tests are designed to serve a dual purpose. The initial set, referred to as AI agent test 304, is dedicated to the evaluation of the AI agent's capabilities. Within AI agent test 304, two distinct categories of tests are administered. The first category is the ‘validate user’ test 306, which is designed to authenticate the identity of users engaging with the system, thereby ensuring their authenticity. Typically, the validate user test 306 configured to verify whether the AI agent behavior aligns with a known user identity or profile, i.e. whether the user's inferred characteristics match their purported identity or typical behavior profile. The second category is the ‘clone detection test’ 308, focused on the detection and identification of potential duplicate agents or fraudulent activities that may seek to imitate legitimate users. Typically, the clone detection test 308 detects whether the AI agent 302 is imitating another agent or identity based on inference patterns or response characteristics. The inference patterns refer to the logical structure, depth, and type of conclusions an AI agent draws from available data, including the sequence and frequency of such inferences. The response characteristics include timing, tone, language style, output structure, and contextual alignment of the AI agent's responses during interaction. In the clone detection test 308, these attributes are analyzed to determine whether the AI agent 302 is imitating another known agent or identity. A close match to the behavioral or inferential signature of another agent-especially when not authorized—may indicate an attempted impersonation or cloning event.

In addition to the initial set of tests, a secondary set, termed validation test 310, fortifies the defense mechanisms of the system. Typically, for validation test 310 the system 102 retrieves factual data access permissions and explicitly defined inference permissions associated with the AI agent 302 from a secure cloud-based enclave and compares the AI agent's observed data access and inference permissions with the retrieved permissions to detect unauthorized or excessive inferential behavior. Typically, excessive inferential behavior refers to instances where an AI agent generates conclusions, predictions, or user-specific insights that exceed its explicitly authorized inference scope. This includes making inferences from data it was not permitted to access, drawing conclusions that combine multiple datasets in unauthorized ways, or exhibiting predictive capabilities beyond its granted inferential boundaries. Such behavior may indicate that the agent has derived sensitive or private knowledge without sufficient basis or consent, potentially violating data governance policies. The system detects this by comparing the AI agent's observed inferences with the predefined factual data access permissions and explicitly defined inference permissions stored within the secure cloud-based enclave. Through the systematic scrutiny of a diverse array of data types and the execution of intricate testing protocols, system 102 establishes a robust protective barrier against fraudulent activities. This approach, aimed at creating a secure and dependable environment for all users, underscores the system's unwavering commitment to enhancing security and trustworthiness. The fraud detection module 312 detects a fraud event based on outputs from the clone detection test 306, validate user test 308, and validation test 310.

As used herein, inferential boundaries refer to predefined constraints that govern the scope, type, and context of inferences that an AI agent is permitted to derive from available data. These boundaries define which conclusions, behavioral predictions, or contextual insights an agent may generate based on specific data sources and under specified conditions. Inferential boundaries are distinct from data access permissions in that they regulate not only what data an agent can see, but also what knowledge it is allowed to infer from that data. These boundaries may be enforced through logical rules, cryptographic tokens, or policy-based controls within a secure cloud-based enclave, ensuring that the AI agent operates within ethically and contractually acceptable limits of interpretation and knowledge generation.

According to an embodiment, the fraud event is detected based on the clone detection test 306 alone, validate user test 308 alone, validation test 310 alone or a combination of one or more of these tests.

In an embodiment, besides core data, data could be in the form of sounds like voice, tonal information, inflections and innovations in the voice. It could be sounds associated with the user, natural or manmade sounds.

In an embodiment, data could also be in the form of mannerisms, behaviors, body language, clothing, style and accessories.

The method and system of the present invention utilizes a broad spectrum of data inputs for generating the inferential knowledge profile. The data includes immutable facts, user behaviors, interaction histories, contextual data, sounds, mannerisms, etc.

Factual Data: The explicit information exchanged between agents or between agents and users.

Inferences: The intermediate and final conclusions, hypotheses, or insights generated by any AI agent during an interaction.

Behavioral Information: Contextual data about the interaction itself, such as response times, confidence scores of inferences, interaction pathways chosen, frequency of requests, or even biometric data if “tone, mannerism, how you dress” are incorporated into agent representation.

Feedback: Explicit or implicit feedback from users or other agents on the suggestions or actions of an AI agent.

The secure cloud-based enclave may be the trusted environment for securely storing sensitive factual data; securely generating, storing, and managing the inferential knowledge profiles; enforcing permissions not just on raw data access, but on the scope and types of inferences that may be drawn by various AI agents; and providing the computational trust needed for the AI Agent Tests to operate reliably, especially when evaluating inferential behavior. The interaction flow involving the secure cloud-based enclave in the context of FIG. 3 (fraud detection incorporating inferential knowledge) relies on defined communication protocols. When the AI Agent test module 304 performs the validate user test 306 or clone detection test 308, it queries the AI agent 302. The AI agent's responses, which may reflect its inferential knowledge, are processed. For the validate user test (306), the system accesses the user's inferential knowledge profile, securely managed within the enclave and compares the inferred characteristics against the purported identity of the AI agent. Communication for accessing these profiles involves secure API calls to the enclave, ensuring data integrity and confidentiality. In the case of the clone detection test 308, inference patterns exhibited by the AI agent 302 are compared against known signatures (behavioral/response characteristics or inferential), which may also be stored or managed by the secure cloud-based enclave if they pertain to registered agents and their authorized inferential styles.

Furthermore, during the validation test 310, the system retrieves both the factual data access permissions and, critically, the inference permissions associated with the AI agent 302 directly from the secure cloud-based enclave. This retrieval occurs via secure, authenticated communication channels governed by protocols ensuring that only authorized system components may access these sensitive permission sets. The enclave acts as the authoritative source for these inferential boundaries. The comparison between the AI agent's observed inferential behavior and the permissions maintained by the enclave involves secure data exchange, potentially utilizing internal enclave mechanisms if the comparison logic itself is executed within the Trusted Execution Environment (TEE) of the enclave. Any fraud event detected by the fraud detection module 312, based on discrepancies in expected versus demonstrated inferences, is then logged, potentially to an immutable audit trail also managed by or anchored to the enclave. External interactions, such as an AI agent within a marketplace cryptographically attesting to the basis of its inferences, would involve the enclave verifying this attestation against its stored records of permitted data and inference rules using secure communication protocols like extensions to OAuth 2.0 that incorporate ‘inference scopes’.

The system synthesizes information from a wide array of diverse data modalities as explained above (e.g., textual data, transactional records, user interface interactions, voice tone, mannerisms, clothing styles, interaction timings) to construct and test the inferential knowledge profiles.

In an embodiment, the secure cloud-based enclave is implemented as a digitally isolated processing zone configured for the privacy-preserving storage, access, and training of AI agents. The secure cloud-based enclave is designed to prevent any unauthorized data exposure, even from system administrators or the cloud infrastructure hosting the enclave. This is achieved using hardware-based isolation techniques such as a Trusted Execution Environment (TEE), wherein the enclave's memory and execution states are cryptographically secured, and remote attestation ensures only authorized code is executed within the enclave.

The secure cloud-based enclave manages the complete data lifecycle, including ingestion, classification, transformation, processing, and deletion of user data, without breach of privacy. Upon receiving data through a data acquisition module, the secure cloud-based enclave classifies the user data into general information, personal information, and secret information, each governed by a distinct level of sensitivity and associated risk. These classifications are used to apply appropriate transformation techniques before data is utilized for training or inference operations.

The secure cloud-based enclave supports different data transformation techniques depending on the classification of the data. General information may be processed with standard encryption. Personal information is anonymized using stripping of identifiers, generalization, and differential privacy techniques. Additionally, random numeric indexing is used where sensitive preferences are mapped to internally stored numeric categories, which remain inaccessible externally. For secret information, the secure cloud-based enclave applies secure cryptographic hashing with a timestamp and cryptographic seed to prevent replay or impersonation attacks. These transformations ensure that the external systems interacting with the secure cloud-based enclave may neither reverse-engineer nor correlate user-specific data.

In an embodiment, the secure cloud-based enclave strictly enforces cryptographic safeguards including one-way hashing, time-bound validity of hashes, periodic key rotation, and ephemeral indexing. These measures prevent external agents from establishing persistent user profiles or tracking across sessions. For example, a user's interest in a specific category is represented as a transient numeric index within the enclave, and this index is periodically regenerated to invalidate any external attempts at user re-identification.

Once the user-specific AI models are trained, the AI agent operates autonomously within the secure cloud-based enclave. The AI agent handles inference and recommendation tasks in accordance with user-defined privacy policies. The AI agent is configured to selectively assimilate external inputs based on contextual relevance, and all outputs are filtered through policy-enforced APIs. External AI systems may engage with the AI agent only through secure, pre-approved interfaces and must participate in a bidding or payment protocol to access compute cycles, without ever accessing the underlying user data.

The secure cloud-based enclave maintains immutable audit logs, optionally backed by blockchain or append-only secure storage, to ensure regulatory transparency and accountability. All interactions, whether internal or external, are cryptographically logged and may be audited by users, regulators, or designated tools without compromising the content processed within the enclave. Session-specific keys and access tokens are ephemeral and destroyed post-interaction to uphold forward secrecy.

The generation of tamper-proof, verifiable audit trails (originating from the secure cloud-based enclave) meticulously log the factual data disclosed to each AI agent, the precise inferential permissions (boundaries of what it's allowed to infer) granted to each AI agent, the interactions and data generated by the agent. The results of tests comparing the agent's behavior against these factual and inferential boundaries helps to identify fraud event.

Mechanisms are available for using the audit trails to enforce accountability—whether through automated marketplace sanctions (e.g., suspension, trust score adjustment) or by providing verifiable evidence for legal or contractual proceedings against “bad actors.”

The secure cloud-based enclave includes “permission to infer” as a distinct, first-class, manageable, and auditable right. This goes significantly beyond traditional data access rights (read, write, delete). It involves defining what types of inferences an agent is allowed to make, from which specific datasets, and under what conditions or contexts. The secure could-based enclave is not just a vault for data but an active governance engine for inferential processes, it may use cryptographic methods to technically enforce or verify these inferential boundaries.

In an exemplary embodiment, the system 102 collects, processes, and stores a wide spectrum of user-related data, including factual, behavioral, and contextual information as previously described. The system 102 has the ability to construct and maintain an inferential knowledge base for each user and potentially for AI agents themselves. This inferential knowledge base includes likely preferences, predicted behaviors, and the basis for these inferences (e.g., derived from specific interactions or datasets). The inferential knowledge profile is created based on this inferential knowledge base.

The system 102 dynamically generates, evolves, and adapts inferential knowledge profiles for users and AI agents in real-time or near real-time. This isn't a static definition but a “living” understanding that shifts with new interactions, changing contexts (e.g., social vs. financial, work vs. home), and evolving user preferences. The system 102 learns and adapts the baseline for expected and authorized inferential behavior. The AI Agent Tests (304, 310) then evaluate against this dynamic, context-sensitive inferential profile. This allows for more accurate detection of truly anomalous or unauthorized inferences that rigid systems might miss or misinterpret.

An AI agent marketplace allows users to securely upgrade, exchange, or sell AI agent modules (skills, datasets, behaviors) transparently and safely to encourage innovation, maintains agent effectiveness, and supports open innovation. The AI agent marketplace may be a decentralized marketplace. The AI agent marketplace may hereinafter be referred to as the marketplace.

In an embodiment, the AI agents may cryptographically attest to the basis of their significant inferences when interacting within the marketplace. The secure cloud-based enclave may then verify if this basis aligns with permitted data and inference rules. The protocol such as Extending OpenID Connect or OAuth 2.0 frameworks include “inference scopes” alongside data scopes. Agents would request permissions to infer specific types of information, and these grants would be tokenized and verifiable

In an embodiment, the secure cloud-based enclave applies techniques such as differential privacy before release of aggregated inferential data (e.g., for market trends), making it impossible to reverse-engineer specific individual inferences if the data is ever legitimately shared for broader analytics.

In another embodiment, a marketplace agent may use Zero-Knowledge Proofs (ZKPs) to prove to the secure cloud-based enclave (or even directly to a user's local agent) that an inference it made (e.g., a recommendation) is derived only from the legitimately shared data and permitted inferential pathways, without revealing the exact inferential process if the data is proprietary, yet still assuring compliance.

The system 102 is configured to initiate at least one remedial action upon detection of the fraud event. The remedial action includes but not limited to AI agent suspension, trust score reduction, user notification, or logging the fraud event in an immutable audit log. The secure cloud-based enclave is configured to enforce permission to infer an auditable right. It is distinct and separate from raw data access permissions. The system (102) is integrated with a marketplace platform that enables registration, monitoring, and governance of AI agents interacting with user data under defined inferential permission constraints.

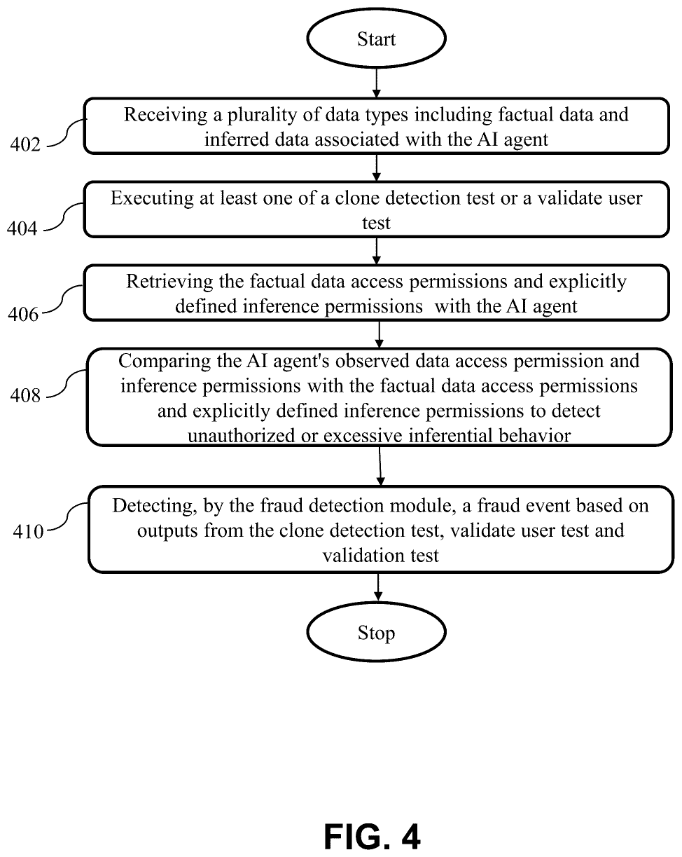

FIG. 4 illustrates a flow chart of a method for detecting fraud through artificial intelligence (AI) agent testing, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, a fraud detection module 312 receives a plurality of data types including factual data and derived inferential knowledge associated with an inferential knowledge profile of the AI agent 302. The inferential knowledge profile may be a part of the secure cloud-based enclave. At block 404, an AI agent test module 304 executes at least one of a clone detection test or a validate user test. The validate user test 306 is configured to verify whether the AI agent's behavior aligns with a known user identity or profile whereas the clone detection test 308 is configured to detect whether the AI agent is imitating another agent or identity based on inference patterns or response characteristics.

At block 406, the factual data access permissions and explicitly defined inference permissions associated with the AI agent may be retrieved from a secure cloud enclave. At block 408, a validation test (310) compares the AI agent's observed data access permission and inference permissions with the factual data access permissions and explicitly defined inference permissions to detect unauthorized or excessive inferential behavior. At block 410, the fraud detection module 312 detects a fraud event based on outputs from the clone detection test, validate user test and validation test.

In an embodiment, the method 400 may further include initiating at least one remedial action upon detection of the fraud event, wherein the remedial action includes but not limited to AI agent suspension, trust score reduction, user notification, or logging the fraud event in an immutable audit log.

In another embodiment, the secure cloud-based enclave stores an inferential knowledge profile including authorized inference types, reference behavior models, and context-sensitive access conditions for each AI agent. The secure cloud-based enclave maintains immutable audit logs detailing the data access, inferential permissions granted, and the inferences actually made by the AI agent, for use in legal or contractual enforcement.

### Exemplary Conducting a Tests of Artificial Intelligence (AI) Agent:

Consider a scenario that the system 102 conducts a plurality of tests of artificial intelligence (AI) agent 302. These tests cover an extensive array of data types stored in the data repository, ranging from factual and immutable data to inferred data types. These tests represent a fundamental component of a cutting-edge AI security framework designed to ensure the system's effectiveness in detecting and mitigating potential risks and fraudulent activities. The scope of these tests is vast, as they encompass a diverse spectrum of data types meticulously stored within the system's 102 extensive data repository. This spectrum ranges from factual and immutable data, which includes user profiles, transaction records, and other unalterable information, to more intricate and nuanced inferred data types. By subjecting the AI agent 302 to this rigorous examination, the system aims to fortify its security measures and reinforce its ability to maintain a secure and trustworthy environment for users.

### Exemplary Scenario 1

The system 102 may possess the capability to incorporate a categorization process that adapts as it advances through the funnel, accommodating alterations and fluctuations. The challenge encountered as one delves deeper into the funnel lies in the potential shifts in user preferences. For instance, an individual's food preference may primarily be Japanese, but occasionally, they might favor Italian cuisine. Consequently, the categorization process must be designed to flexibly address these variations that emerge when navigating deeper into the funnel.

### Exemplary Scenario 2

Consider a scenario of data validation and duplicate detection, in which the process of validating data is under consideration. The concept revolves around agreed-upon registration, wherein specific, predefined items are established as “allowable” for the central server to access and examine. This registration process serves as the basis for conducting tests. When another system is queried regarding these predefined items and provides a response closely resembling that of the central server, it raises suspicions of potential duplication. The presence of a sufficient number of such similarities triggers the identification and flagging of a potential duplicate agent. This scenario highlights the significance of data validation and the implementation of measures to identify and address the possibility of duplicate agents, enhancing the integrity and efficiency of the system 102. For instance, imagine an online authentication service where users register their unique personal identifiers, such as fingerprint scans and facial recognition data, with the central server for secure access. This registered data forms the agreed-upon registration, allowing the central server to validate users' identities during login attempts. In this scenario, if an unauthorized system attempts to mimic these user identifiers and yields responses strikingly similar to the central server's, it triggers alerts of potential duplication. The presence of multiple such suspicious attempts enables the system to flag these as potential duplicate agents, safeguarding user identity and system security by thwarting fraudulent access attempts. This example mirrors the real-world importance of robust data validation and the need to detect and address duplicate agents efficiently.

### Exemplary Scenario 3

Consider the system 102 is engaged in the process of conducting validation tests to verify the identity of the user. These tests serve the crucial purpose of comparing the user's identity with that of the AI Agent 302. The validation tests 310 are designed to encompass a wide range of data points, with a particular focus on data collected directly from the user. This data can be gathered during significant interaction points within the system or at the time of the user's registration. The overarching goal of these validation tests 310 is to ensure a high level of accuracy in establishing and confirming the user's identity, reinforcing the system's security and trustworthiness. This scenario underscores the importance of robust identity verification processes within the system 102. For example, consider a modern smartphone equipped with facial recognition technology. In this scenario, system 102 plays a pivotal role in conducting validation tests to verify and validate the user's identity. These tests are multifaceted, encompassing not only facial features but also other personal data points, like voice recognition and fingerprint scans, that have been collected directly from the user during various interactions with the device. This comprehensive approach ensures a high level of accuracy in confirming the user's identity, bolstering the smartphone's security and trustworthiness. This example highlights the real-world importance of robust identity verification procedures, making the device more secure and reliable for its users.

### Exemplary Scenario 3

In an AI agent marketplace, when an AI agent (e.g., a third-party service, a personalized shopping assistant) is registered in the marketplace, its access to user data is defined. This includes defining the boundaries of permissible inferences the AI agent may make based on the user data. These permissions are recorded within the secure cloud-based enclave. A user may interact with a marketplace AI agent. The system 102 (via the secured cloud based enclave) monitors the interaction or receives reports/queries from the user or the marketplace agent itself. The marketplace agent might explicitly state certain inferences about the user (“Based on your recent interest in X, I recommend Y”) or its actions might implicitly reveal unstated inferences. The system 102 compares the marketplace agents demonstrated or claimed inferences against the user's recorded inferential knowledge profile and the agent's explicit permissions for inference stored in the secured cloud based enclave. For instance, if a user only shared their interest in “action movies” (factual data), but the agent starts making highly specific recommendations based on an inferred “preference for 1980s niche action-comedy films,” the system 102 may flag this. The system 102 checks if the agent is claiming knowledge/making inferences that exceed its granted scope.

A “bad actor” is identified if the marketplace agent demonstrates knowledge or inferences as follows: exceed the factual data explicitly shared with it, violate the defined boundaries of permissible inferences recorded in the enclave, contradict the user's known (and tracked) inferential profile in unexpected ways, suggesting external data acquisition or illicit profiling, the agent claims to possess or acts upon more information (especially inferred) than what was legitimately recorded or permitted by the user/system.

In order to handle the bad actors, the immutable audit logs within the secure cloud based enclave, detailing exactly what data and inferential permissions were granted versus the inferences the agent actually made, may serve as verifiable evidence of data misuse, breach of contract (terms of service in the marketplace), or privacy violations. This strengthens legal recourse.

Through the marketplace governance automated sanction, trust score reduction, revocation of license/certification, user alerts may be provided to handle bad actors. The automated sanctions in the marketplace (governed by the enclave's findings) may automatically restrict the bad actor agent's access to further data, limit its functionalities, or suspend its operations. The agent's reputation or trust score within the marketplace may be downgraded, making it less likely to be engaged by users. The agent may be delisted or have its marketplace participation rights revoked under revocation of license/certification. The users may be notified if an agent they interacted with has been found to overstep its informational boundaries.

In a practical example consider “Personalized News Aggregator” AI agent in a marketplace. The secure cloud based enclave may perform the following:
1. Permissions: A user grants this AI agent access to their “preferred news topics” (factual: e.g., “technology,” “space exploration”) and permits “basic sentiment inference” related to these topics. These permissions are logged in the secure could-based enclave. The enclave also maintains a broader inferential profile of the user from other consenting services.
2. Interaction: The News Aggregator agent recommends an article highly critical of a specific political figure.
3. Verification:
   The user, or the secured cloud based enclave's monitoring system, flags this. The user never explicitly shared political leanings with this specific agent.
   The enclave checks:
      Was “political leaning” a shared factual data point with this agent?No.
      Was “inferring political stance” a permitted inferential scope?No.
      Does the enclave's broader (but permissioned) inferential profile of the user strongly suggest this leaning, and could the agent have indirectly (but still illicitly, given its limited permissions) picked this up?

The system 102 as detects the agent made who made inference without a legitimate basis (i.e., it obtained this info from an unauthorized source or made an inference beyond its permissioned scope), then such agent's may be flagged. After flagging, the News Aggregator agent's trust score is reduced, and it may be temporarily suspended from accessing user data. A warning is issued regarding its inferential overreach. If this is a pattern and the agent is found to be systematically building illicit detailed profiles, the audit logs from the secure cloud based enclave illustrates specific instances of inferential overreach against explicit permissions may be used as evidence.

In another example scenario, if an agent makes an unauthorized inference, the system may help to demonstrate why it was unauthorized (e.g., “based on data X it wasn't given access to,” or “used an inferential method Y it wasn't permitted”). This is crucial for dispute resolution and for distinguishing between genuine errors and malicious intent. This provides an unprecedented level of granularity for accountability.

The present disclosure incorporates the tracking, testing, and permissioning of inferential knowledge, especially within a marketplace framework governed by a secure cloud-based enclave. It addresses a sophisticated emerging challenge in AI ethics and data privacy—how to ensure AI agents are not just using data correctly, but are also making fair, transparent, and authorized inferences.

Embodiments of the present disclosure provides a system and methods for detecting fraud through artificial intelligence (AI) agent testing. This provides a more profound and robust method for AI agent scrutiny. By making inferential knowledge an explicit, testable component, the system may detect subtle forms of fraud, unauthorized data exploitation (where an agent infers more than it should), and a wider range of anomalous behaviors, leading to more trustworthy AI interactions.

The secure cloud-based enclave is specifically architected for the protected management of not just factual data, but also the derived, sensitive inferential knowledge profiles. Mechanisms are implemented within the secure cloud-based enclave for defining, storing, and enforcing granular permissions related to the scope of allowable inferences an AI agent may make, distinct from mere data access permissions. The execution of the AI agent testing processes (including inferential knowledge tests) within the trusted environment (secure cloud-based enclave) to ensure the integrity and confidentiality of the testing process itself. The secure cloud-based enclave provides secure and auditable logging of data access, permission grants (including inference permissions), and the outcomes of these tests. Hence the secure cloud-based enclave provides a high-assurance platform to protect sensitive inferential knowledge from unauthorized access or tampering. It enables an access control based on “permission to infer,” allowing for more nuanced governance of AI agents. It also ensures that the validation of these agents is itself performed in a secure and reliable manner.

The system, through the secure cloud-based enclave's audit trails, may establish a verifiable causal chain—or identifying the absence thereof—for significant inferences made by an AI agent. This capability extends beyond merely logging that an inference is made; it enables the system to provide traceable evidence linking the inference to authorized input data and sanctioned inferential pathways. Where such linkage is absent or unauthorized, the system may flag the inference as non-compliant or potentially erroneous, thereby enhancing accountability, data governance, and trust in AI-driven decision-making.

The present disclosure provides the technical framework for proactive and continuous governance of AI agents in a marketplace to detect discrepancies. This may include periodic inferential audits of agents or analyzing patterns of inferential behavior across the marketplace to identify emerging risks or collusive activities. Hence, the system doesn't wait for an AI agent to make an unauthorized inference, it may assess the AI agent's potential to make unauthorized inferences based on its architecture, its data requests, or subtle patterns in its “near-boundary” inferential behavior. This allows the marketplace to identify and mitigate risks before significant harm occurs. The feedback loop for dynamic permission adjustment based on observed inferential patterns is a key inventive element here.

By systematically comparing an agent's demonstrated inferential capabilities with its explicit authorizations stored in the secure cloud-based enclave, the system may identify and address “bad actors” or non-compliant agents that overstep their informational boundaries, thereby fostering a more transparent and trustworthy AI ecosystem. It also creates a foundation for strong AI agent accountability. By providing a trusted and detailed record of both an agent's entitlements (factual and inferential) and its observed behavior, it becomes possible to definitively prove transgressions and enforce consequences, thereby deterring misuse and providing recourse for affected parties.

For the sake of brevity, the construction and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

The system and method disclosed by the present disclosure not only uses multiple data types but also provides fusion and synthesis of different modalities specifically for the purpose of understanding and validating an AI agent's inferential state and capabilities. The present disclosure helps in detecting anomalies wherein the agent might be factually correct based on text, but its inferential behavior (indicated by interaction timing or response style when combined with other data) could be anomalous.

Embodiments of the present disclosure provide systems and methods for detecting fraud through artificial intelligence (AI) agent testing. The present disclosure conducts a plurality of tests of artificial intelligence (AI) agent, each encompassing a comprehensive range of data types stored in the data repository, spanning from factual, immutable data to inferred data types. The present disclosure enables a categorization process as it progresses through the funnel, accounting for variations and changes. Further, the present disclosure conducts tests on data that has been pre-approved through an agreed-upon registration process, representing fixed items that the central server is authorized to access and assess. In cases where another system is queried, and it provides a response closely resembling the authorized data, suspicions of duplication may be raised. If a sufficient number of such similarities are identified, it would trigger the identification and flagging of a potential duplicate agent.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1) A method for detecting fraud through artificial intelligence (AI) agent testing, comprising:
receiving, by a fraud detection module, a plurality of data types including factual data and derived inferential knowledge associated with an inferential knowledge profile of the AI agent;
executing, by the AI agent test module, at least one of a clone detection test or a validate user test, wherein:
the validate user test configured to verify whether the AI agent behavior aligns with a known user identity or profile; and
the clone detection test configured to detect whether the AI agent is imitating another agent or identity based on inference patterns or response characteristics;
retrieving, from a secure cloud-based enclave, the factual data access permissions and explicitly defined inference permissions associated with the AI agent;
comparing, by a validation test, the AI agent's observed data access permission and inference permissions with the factual data access permissions and explicitly defined inference permissions to detect unauthorized or excessive inferential behavior; and
detecting, by the fraud detection module, a fraud event based on outputs from at least one of the clone detection test, validate user test or validation test.

2) The method as claimed in claim 1, comprising initiating at least one remedial action upon detection of the fraud event.

3) The method as claimed in claim 2, wherein the remedial action includes but not limited to AI agent suspension, trust score reduction, user notification, or logging the fraud event in an immutable audit log.

4) The method as claimed in claim 1, wherein the secure cloud-based enclave stores the inferential knowledge profile comprising authorized inference types, reference behavior models, and context-sensitive access conditions for each AI agent.

5) The method as claimed in claim 1, wherein the secure cloud-based enclave maintains immutable audit logs detailing at least one of data access by the AI agent, inference permissions granted, and inferences made by the AI agent.

6) The method as claimed in claim 1, comprising tracking and enforcing permission to infer within the secure cloud-based enclave as an auditable right.

7) The method as claimed in claim 1, comprising registering, monitoring and governing one or more AI agents in a marketplace platform, wherein the AI agents interact with user data under defined inferential permission constraints.

8) A system for detecting fraud through artificial intelligence (AI) agent testing, the system comprising:
one or more processors; and
a memory storing programmed instructions executable by the one or more processors, wherein the one or more processors execute the programmed instructions to:
receive, by a fraud detection module, a plurality of data types including factual data and derived inferential knowledge associated with an inferential knowledge profile of the AI agent;
execute, by an AI agent test module, at least one of a validate user test or a clone detection test, wherein:
the validate user test configured to verify whether the AI agent behavior aligns with a known user identity or behavior profile; and
the clone detection test configured to detect whether the AI agent is imitating another agent or identity based on inference patterns or response characteristics;
retrieve, from a secure cloud-based enclave, the factual data access permissions and explicitly defined inference permissions associated with the AI agent;
compare, by a validation test module, the AI agent's observed data access and inference permissions with the retrieved permissions to detect unauthorized or excessive inferential behavior; and
detect, by the fraud detection module, a fraud event based on outputs from at least one of the clone detection test, validate user test or validation test.

9) The system as claimed in claim 8, wherein the one or more processors are further configured to initiate at least one remedial action upon detection of the fraud event.

10) The system as claimed in claim 9, wherein the remedial action includes but not limited to AI agent suspension, trust score reduction, user notification, or logging the fraud event in an immutable audit log.

11) The system as claimed in claim 8, wherein the secure cloud-based enclave stores the inferential knowledge profile comprising authorized inference types, reference behavior models, and context-sensitive access conditions for each AI agent.

12) The system as claimed in claim 8, wherein the secure cloud-based enclave maintains immutable audit logs detailing at least one of data accessed by the AI agent, inference permissions granted, and inferences made by the AI agent.

13) The system as claimed in claim 8, wherein the secure cloud-based enclave is further configured to enforce “permission to infer” as a distinct and auditable right separate from raw data access permissions.

14) The system as claimed in claim 8, wherein the system is integrated with a marketplace platform that enables registration, monitoring, and governance of AI agents interacting with user data under defined inferential permission constraints.

15) A non-transitory machine-readable medium including data, which when used by a system detecting fraud through artificial intelligence (AI) agent testing, causes the system to perform instructions that cause the system to perform operations comprising:
receiving, by a fraud detection module, a plurality of data types including factual data and derived inferential knowledge associated with an inferential knowledge profile of the AI agent;
executing, by the AI agent test module, at least one of a clone detection test or a validate user test, wherein:
the validate user test configured to verify whether the AI agent behavior aligns with a known user identity or profile; and
the clone detection test configured to detect whether the AI agent is imitating another agent or identity based on inference patterns or response characteristics;
retrieving, from a secure cloud-based enclave, the factual data access permissions and explicitly defined inference permissions associated with the AI agent;
comparing, by a validation test, the AI agent's observed data access permission and inference permissions with the factual data access permissions and explicitly defined inference permissions to detect unauthorized or excessive inferential behavior; and
detecting, by the fraud detection module, a fraud event based on outputs from at least one of the clone detection test, validate user test or validation test.
